(19) United States
(12) Patent Application Publication
(10) Pub. No.: US 2002/0189911 A1
(43) Pub. Date: Dec. 19, 2002

(54) Spring for retracting and retaining a pad in a caliper type disc brake assembly

(76) Inventors: Charles Thomas Layton, Beverly Hills, MI (US); Eric John Roszman, Farmington Hills, MI (US); Sean Christopher Barrett, Farmington Hills, MI (US)

Correspondence Address: Conrad J Clark, Clark & Brody, Suite 600, 1750 K Street NW, Washington, DC, 20006, US

(21) Appl. No.: 10/149,291

(22) PCT Filed: Oct. 18, 2001
(86) PCT No.: PCT/US01/27775

(51) Int. Cl. F16D 65/38

(52) U.S. Cl. 188/73.37

(57) ABSTRACT

A disc brake uses retraction springs arranged in directions transverse to the direction of movement of the brake pads. The springs thus apply both tangential and radial forces to the brake pads to both retract the pads and to reduce rattle. In the preferred embodiment, the springs are S-shaped and attached to the pad backing plates by insertion of the ends of the springs into holes in the backing plates.

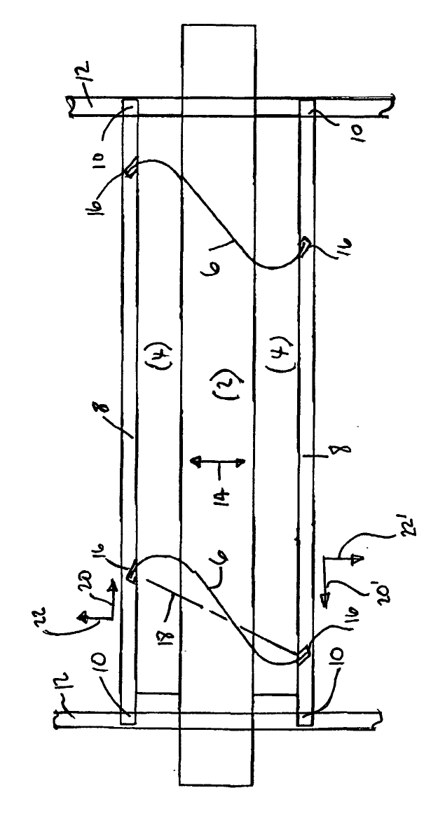

### TECHNICAL FIELD

This invention relates to a caliper-type disc brake. In particular, the invention relates to a spring capable, both, of reducing rattle and retracting the brake pads.

### BACKGROUND OF THE INVENTION

Pad rattle in a caliper disc brake assembly has been addressed by one of three methods. In one solution, the brale pads are secured to the brake piston or to the caliper body. In a second solution, the clearances between the pad and the support bracket are reduced or dampening material is placed in the clearances. Thirdly, a special pad clip has been provided to load the pad in a tangential direction.

The prior methods are not desirable because they all tend to lead to generation of larger disk thickness variation (DTV), for example, because of increased slide loads, increase in component cost, due to added complexity, and cause assembly and its service to be more difficult.

### SUMMARY OF THE INVENTION

In accordance with the invention, a spring is installed between the opposed brake pads in such a manner that the spring applies to the pads a force that is directed in both the tangential and radial directions. (As used herein “tangential” refers to the direction transverse to the direction of caliper piston movement, and “radial” refers to the direction of caliper piston movement.) Preferably, each end of the spring engages a respective hole in the backing plate for a pad. The springs are shaped to apply tangential and radial forces to the pads and, the preferred embodiment uses two S-shaped springs.

The tangential force applied by the springs according to the invention increase the slide load of the pad assemblies and the radial force retracts the pads away from the rotor during non-braking. These advantages are achieved by components no more complex than used with conventional springs and assembly and service are unaffected.

It is an object of this invention to provide an assembly for a disc brake caliper that reduces rattle.

It is a further object of this invention to provide a spring assembly for a disc brake caliper that both reduces rattle and applies retraction forces.

### DETAILED DESCRIPTION OF THE PREFERRED EMBODIMENT

With reference to the drawing figure, a disc brake is illustrated with rotor 2 and opposed disc brake pads 4 on either side thereof. The disc brake pads 4 are mounted on respective backing plates 8, which include ears 10 or other structure for engaging a groove 12 in caliper, which is only partially illustrated in the figure. The ears slide in the groove 12 in known fashion as a result of the braking forces applied by a caliper piston (not illustrated). The engagement between the ears 10 and the caliper groove 12 restricts the motion of the pads 4 to be in the radial direction illustrated by the arrow 14.

It is usually necessary to apply a retraction force to the pads to provide a gap between the pads 4 and the rotor 8 when the braking force is released to prevent drag on the rotor. It is also desirable to apply a force to the pads that will reduce the vibrations of the pad, or “rattle.” In accordance with the invention, a single spring is arranged to apply both a retraction force and a force that reduces rattle.

As illustrated in the figure, two S-shaped springs 6 are preferably applied between the opposed pads by engaging the ends of the springs in holes 16 in the backing plates of the pads. It will be appreciated that the springs apply tangential forces to the pads to urge the pad ears into the channel 12 and reduce rattle and also apply radial forces in the direction of the channel 12 to retract the pads upon release of braking force.

The application of both tangential and radial forces by the springs 6 is the result of the transverse alignment of the springs with respect to the direction of the groove 12 in the caliper. Thus, in the preferred embodiment illustrated, the holes 16 in opposed backing plates 8 are not aligned in the direction of movement of the backing plates, illustrated by arrow 14. Instead, the holes receiving a single spring are shifted in the tangential direction such that they lie on a line as shown at 18 in the FIGURE.

As the pads move inward in the radial direction during braking, the springs 6 are compressed such that the restoring forces applied to the backing plates by the springs 6 are applied in the direction of the line 18. Because these forces are transverse to the radial direction, they contain both radial and tangential components. The tangential force applied by the springs to each baking plate is the tangential component of the line 18 connecting the two holes in each respective pad, and the radial force is the radial component of the line. Arrows 20 and 20′ illustrate the tangential components, and arrows 22 and 22′ illustrate the radial components. Thus, these holes must be located based on the required radial and tangential loads for adequately retracting the pads and eliminating rattle.

Also, as the pads wear, the radial distance between the pads in the rest position is shortened. This means that the angle of the line 18 connecting the holes 16 changes as the pads wear, and this changes the proportion of the force applied by the springs that is radial and tangential for springs such as those illustrated. As the pad lining wears, the spring must be able to account for the natural decrease in the radial force and the increase in the tangential force caused by a change in the relative positions of the holes 16. Applicants have found that a spring of known spring material having, for example, a diameter of 2 mm, and in the S-shape is effective.

The S-shape of the spring as shown has been found advantageous because the curves can accommodate the changes. Clearly, other configurations, including a V-shape or coiled shape are possible. Also, the holes 16 are angled to facilitate assembly of the springs to the backing plates. Other configurations are possible, however. For example, the holes may extend in the direction of caliper movement, or a completely different attachment mechanism, such as a clip or other fastener, may be employed.

Preferably two springs in the same orientation are used. In this manner, the respective tangential and radial components of the two springs are collinear and add to provide increased forces. Arrangements other than the symmetrical arrangement shown may have utility, however.

It should be noted that the element 6 has been referred to herein as a spring. Such is intended to refer to a variety of resilient elements that resiliently resist application of forces to and try to return to their original shape. While the springs are shown acting in compression, it is possible to arrange the springs to operate in tension.

Modifications within the scope of the appended claims will be apparent to those of skill in the art.

We claim:

1. A method for reducing rattle in a disc brake assembly, comprising attaching a spring to a brake pad in such a manner that the spring applies a tangential force and a radial force to said brake pad.

2. A method according to claim 1 wherein there are two opposed brake pads and said spring is attached to each of said two opposed brake pads.

3. A method according to claim 1 wherein said spring is attached between said two opposed brake pads.

4. A method according to claim 3 wherein said spring is S-shaped.

5. A brake assembly comprising a rotor, a respective brake pad on each side of said rotor, and at least one spring attached to each of said brake pads to apply tangential and radial forces to said pads.

6. A brake assembly according to claim 5 wherein said spring is between said brake pads and is S-shaped.

7. A brake assembly according to claim 6 wherein each of said brake pads is mounted to a respective backing plate, and each backing plate has at least one hole therein for receiving an end of said spring, each hole having an axis oriented transverse to the direction of movement of said brake pads.

8. A brake assembly according to claim 5 wherein said brake pads move in a first direction during braking and said spring is arranged to apply a force to said pads in a second direction transverse to said first direction.

9. In a disc brake assembly of the type having two brake pads carried by a caliper for movement in a first direction and a spring placed between said brake pads for returning said brake pads to a rest position, the improvement wherein said spring is arranged between said brake pads to apply a force in a direction transverse to said first direction.

10. The disc brake assembly according to claim 9 wherein said spring is S-shaped.

11. The disc brake assembly according to claim 10 wherein there are two of said springs.

12. The disc brake assembly according to claim 10 wherein each of said brake pads is carried by a backing plate, and each of said backing plates has a hole therein to receive an end of a said spring.
